(19) United States
(12) Patent Application Publication
(10) Pub. No.: US 2012/0110861 A1
(43) Pub. Date: May 10, 2012

(54) Eating Fork With Reverse Tapered Tines

(76) Inventor: Joseph Aurele Jacque Fradet, Valley Center, CA (US)

(21) Appl. No.: 12/940,924

(22) Filed: Nov. 5, 2010

(51) Int. Cl. A47J 43/28

(52) U.S. Cl. 30/322

(57) ABSTRACT

An improved eating fork includes a conventional handle and an extended flat body portion with a plurality of tines that generally taper continuously from narrowest to widest towards the open ends of the fork. The tines taper outward up to the maximum relative width towards the open end of the fork, and the thickness of the tines in this invention reduces gradually towards the open ends. By the increased width and a reduced thickness of the tines towards the end, this invention provides more efficiency in spearing a food item, in scooping a food item, in capturing through a twisting motion of the tines, and in holding or retaining the food item once it has either been initially speared, scooped, or twisted, than a conventional fork.

### FIELD OF THE INVENTION

The present invention relates generally to cooking and eating utensils, and primarily forks. More particularly, though not exclusively, the present invention is related to forks having improved functionality to provide greater utility when utilized in conjunction with varying food types.

### BACKGROUND OF THE INVENTION

The major purpose of the fork as an eating utensil is to spear an item of food and hold that item either while it is being cut into bite-sized portions or to transfer a food item from a plate into the mouth. For many years, the general form and shape of eating forks has not changed. Even though there have been numerous designs of the handles of forks made largely for aesthetic reasons, the general form and shape of the remainder of the fork has remained substantially unchanged. The general form and shape of forks usually consist of a number of conventionally-shaped tines which generally taper continuously from widest to narrowest towards the open ends of the fork.

The major design elements of forks related to utility and not related to aesthetics are intended to satisfy the following requirements: (1) the ability to spear a food item by driving the tines into the item; or (2) the ability to scoop a food item by driving the tines underneath the item; or (3) the ability to capture through a twisting motion of the tines through a group of food items; and (4) the ability to hold or retain that food item once it has either been initially speared, scooped, or twisted onto the fork. In an effort to provide more practical forks in various situations, some variations from the conventional fork have been invented.

For example, earlier fork designs have employed an extended flat body portion and a plurality of short conical tines each having a small smoothly rounded end. U.S. Pat. No. 4,896,423 (1990) adopted much shorter tines of the fork than the conventional tines. The fork contained short tines and the body portion included in its upper surface a rectangular indentation. This invention could be helpful to spear a small food item using the shorter tines and to retain food upon the body portion of the fork. However, because of the shortness and narrowness of the tines, it would have difficulty to capture a food item through a twisting motion of the fork or to scoop a food item.

U.S. Pat. No. 6,105,259 (2000) related to eating utensils configured for use by individuals having diminished capacity, such as small children and the like. This invention contained a fork with a pair of outer tines and a pair of shorter intermediate tines. Each outer tine is flat with a constant thickness. Also, an enlarged and radiused end having a generally circular plan shape reduces the possibility of causing injury to a user's mouth. The intermediate tines are shorter than outer tines, such that the ends of intermediate tines are disposed inwardly from the radiused ends of outer tines. This invention might be helpful to promote grasping for the individuals with disabilities, and to prevent injury through rounded, blunt shapes of tines having a smooth contour. However, the different lengths of outer and inner tines would render this invention hard to retain or hold a food item, or scoop a food item by driving the tines underneath the item, or to capture through twisting motions of the tines.

U.S. Pat. Pub. No. US 2007/0011887 A1 (2007) discloses a fork apparatus that comprises a moveable push plate slidable over the tines of the fork to facilitate removing a food item. This invention comprises a handle having a first end, a second end, and a top surface, where that handle is formed to include a sliding push plate that facilitates sliding the food from the fork.

Another invention, often referred to as the ‘Louis XV’ Pattern Sterling Asparagus Serving Fork made popular in the early 20th century, discloses an invention used exclusively for the serving of foods, from sandwiches, lasagna to dessert. The ‘Louis XV’ adopted non linear and non parallel tines having a constant width and thickness, and bridges between each tine to promote the ability of the fork to scoop or retain the food items. However, due to the bridges between each tine, this invention would not be useful to spear a food item by driving the tines into the item, or to capture a food item such as pasta through a twisting motion of the tines.

All of the variations mentioned above generally perform adequately only one or a few requirements among the four requirements of the forks' utility. Therefore, it would be advantageous to provide a fork which satisfies all of the four requirements in its utility. This invention provides an improved eating fork with elements that optimize utility by performing all four of the requirements, through the unique reverse tapered tines, and a gradual reduction in thickness of the tines towards the open ends.

### SUMMARY OF THE INVENTION

The present invention includes an improved eating fork having a conventional handle, and an extended flat body portion with a plurality of tines, but differing from conventional forks in the shape, separation and utility of its tines. Conventional tines generally taper continuously from widest to narrowest towards the open ends of the fork. The tines in this invention taper outward up to the maximum relative width towards the open end of the fork, and the thickness of the tines in this invention reduces gradually towards the open ends. By the increased width and a reduced thickness of the tines towards the end, this invention provides more efficiency in spearing a food item, in scooping a food item, in capturing through a twisting motion of the tines, and in holding or retaining the food item once it has either been initially speared, scooped, or twisted, than a conventional fork.

The tines in this invention increase in the width, but decrease in the thickness, towards the open ends of the fork. By the variations in the tines with the flattened tips of the tines at the open end, this invention provides an eating fork satisfying all of the four requirements of the forks' utilities, such as more efficiency in spearing, scooping, capturing through a twisting motion of the tines, and in holding or retaining the food item.

### BRIEF DESCRIPTION OF THE DRAWING

The nature, objects, and advantages of the present invention will become more apparent to those skilled in the art after considering the following detailed description in connection with the accompanying drawings, in which like reference numerals designate like parts throughout, and wherein:

FIG. 1 is a top plan view of the eating fork with reverse tapered tines of the present invention;

FIG. 2 is a top plan view of the tines shown in FIG. 1;

FIG. 3 is a top plan view of the open end of the tapered tine;

FIG. 4 is a cross-sectional view taken along line 4-4 of the fork shown in FIG. 1;

FIG. 5 is a cross-sectional view taken along line 5-5 of the fork shown in FIG. 1;

FIG. 6 is a cross-sectional view taken along line 6-6 of the fork shown in FIG. 1;

FIG. 7 is a partial cross-sectional view of the eating fork with reverse tapered tines as used with a typical food requiring a twisting motion such as spaghetti;

FIG. 8 is a top plan view of the eating fork with reverse tapered tines of the present invention as used to eat small food items, such as peas;

FIG. 9 is an alternative embodiment of the eating fork with reverse tapered tines of the present invention showing a number of symmetrical tines having parallel and constant cross-sectional tine sections leading to a reverse tapered end;

FIG. 10 is an alternative embodiment of the eating fork with reverse tapered tines of the present invention showing a number of parallel tines having parabolically narrowing widths leading to a reverse tapered end

FIG. 11 is an alternative embodiment of the eating fork with reverse tapered tines of the present invention showing a number of tines having a constant taper from the base to the end of the tine;

FIG. 12 is an alternative embodiment of the eating fork with reverse tapered tines of the present invention showing a number of tines, with two outer tines being non-parallel and having an asymmetrical end, and two inner tines that are parallel and having symmetrical ends;

FIG. 13 is an alternative embodiment of the eating fork with reverse tapered tines of the present invention showing a number of tines, including a tine without a reverse taper, two parallel internal tines having constant cross-section leading to a reverse tapered end; and an non-parallel outer tine having an asymmetrical end; and

FIG. 14 is an alternative embodiment of the eating fork with reverse tapered tines of the present invention showing a number of parallel and constant cross-section tines having two asymmetrical outer ends, and two inner symmetrical ends.

### DETAILED DESCRIPTION OF A PREFERRED EMBODIMENT

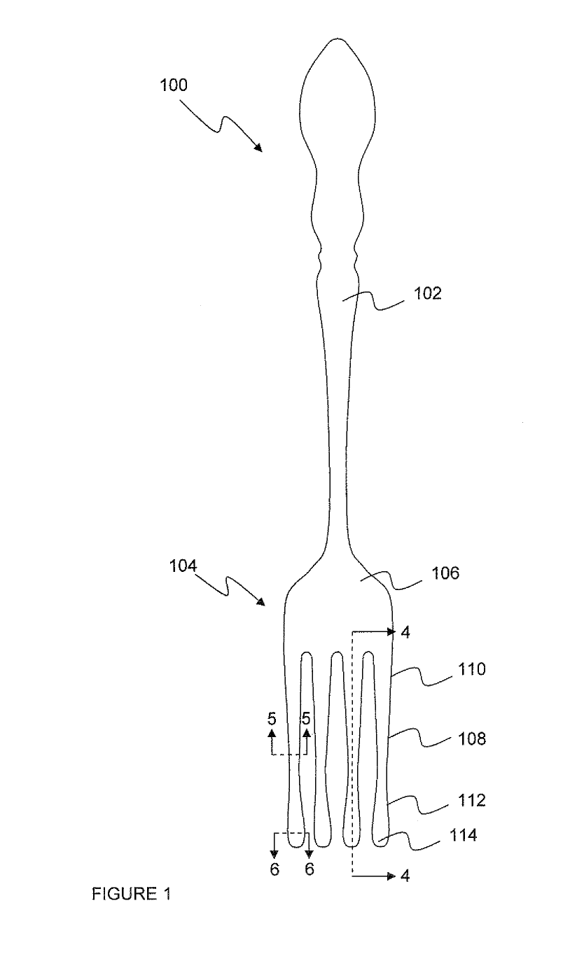

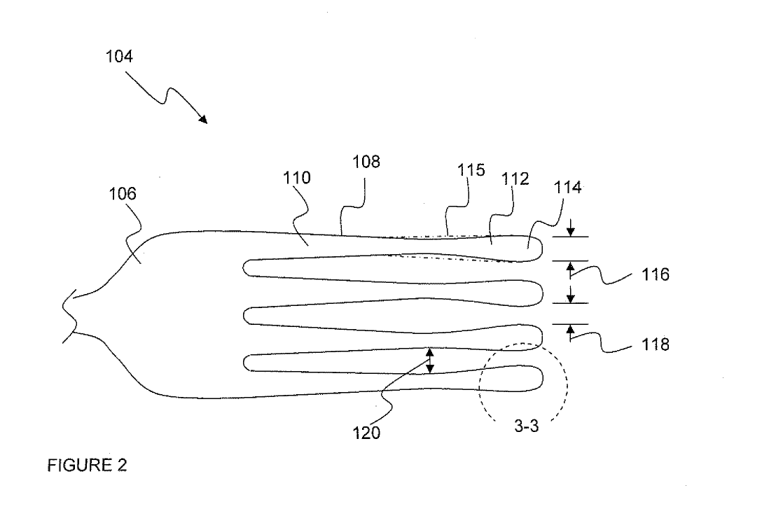

Referring initially to FIG. 1, this invention includes an improved eating fork 100 having a fork handle 102 and a fork head 104. The handle 102 may be of any conventional design known in the art. Head 104 includes a base 106 and a plurality of tines 108. As shown in FIG. 2, the tines 108 in present invention comprises two parts: (1) a first portion 110 having a consistent cross-section; and (2) a second portion 112 having a reverse taper. Both of the portions 110 and 112 would be made of the same material. First portion 110 has a consistent width and shape, and a substantially constant cross-section. However, the second portion 112 of the tine 108 is formed to taper outward to tip 114 having a maximum relative width 116 towards the open end of the fork 100. Even though tine 108 is wider at the tip 114 than those a conventional fork, the tines 108 are separated by a gap 118 and can also adequately spear food, satisfying the first requirements in the forks' utility. Each tine end 114 may be formed with a radius 116, or the end 114 may be formed with a curvature that is not radial, such as an elliptical or higher-order curvature. Also, end 114 may be concave or convex or linear to facilitate use of the present invention with various food groups.

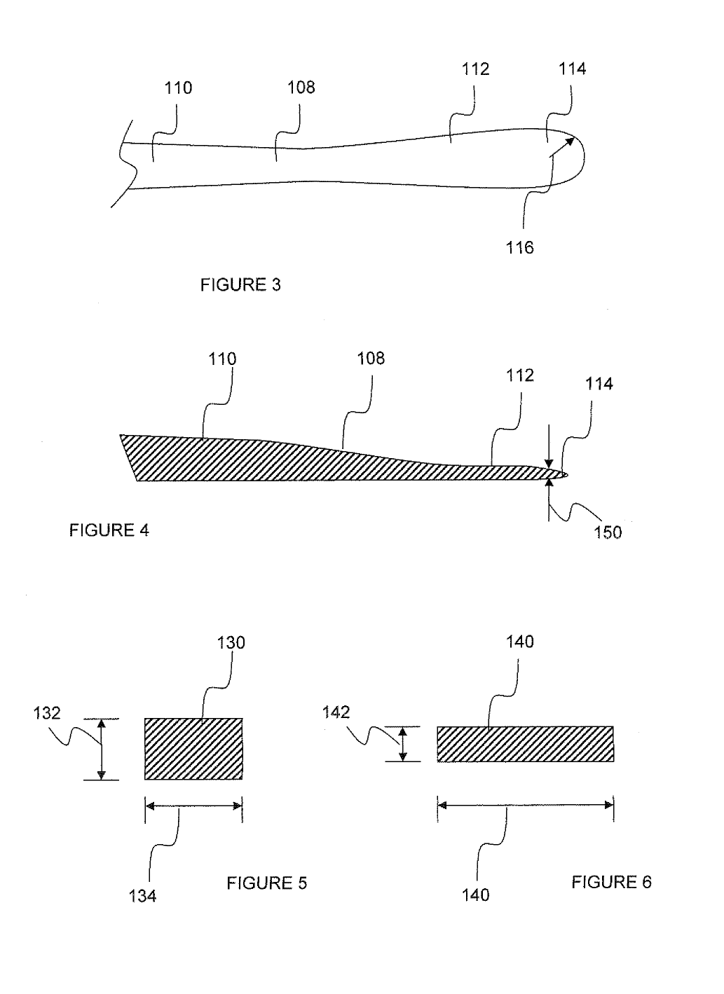

Referring to the detail drawing shown in FIG. 3, an enlarged view of second portion 112 of tapered tine 108 is shown. From this view, the flared shape and the absence of any sharp edges of the tine 108 can be easily appreciated. It is to be appreciated that the tine 108 may be formed with sharpened tips or edges to facilitate use with specific food types. As shown in this Figure, the tapering of the tine 108 is shown to have a curvature, e.g. a non-linear surface, from the first portion 110 to end 114. It is to be appreciated that a non-curved, e.g. linear, surface may be used, such as that shown by dashed line 115 in Referring to FIG. 4, a cross-sectional view of fork 100 taken along line 4-4 of FIG. 1 shows a gradual reduction in the thickness of the tines towards the ends 114. Due to the thinner convex shape of the tine 108 at the distal end 114, the cross-sectional area of the tines at the tips remain largely unchanged and therefore the resistance of a food item to a spearing force and motion are offset, and thus, remain unchanged. For instance, referring to FIG. 5, a cross-sectional view of tine 108 taken along line 5-5 shows a cross-sectional area 130 throughout the first portion 110 of the tine 108. In a preferred embodiment, this portion 110 has a typical height 132 of 3/32 of an inch and a typical width 134 of ⅛ to 5/32 of an inch. FIG. 6 is a cross-sectional view of the second portion 112 of tine 108 taken along line 6-6 of FIG. 1, and shows a cross-sectional area 140 having a height 142 and a width 144. It is to be appreciated that the tines 108 in the present invention are gradually wider, but thinner, as the tine extends from the handle 102, which provides for a substantially constant cross-section along the length of the tine 108.

In use, the substantially flat end 114 of the tine 108 has the ability to scoop food items because they more easily slide over the flatter surface of end 114. Once the food items are on the surface of the fork and beyond the widest edge of the tine, the food items tend to settle into position between the tines 108 and stay on the fork as the reverse taper provides increased surface friction to stop foods from falling off the end of the fork 100. Also, as shown in FIG. 4, a scoop 150, or cradle, is created by the shape of the tines 108 and stops food from sliding off the fork by opposing gravitational forces.

The diameter of cooked spaghetti is generally known as 3/32″ as measured empirically using a common store brand as well as by specification of some well-known pasta machines. The diameter of uncooked short-grain rice is greater than 1/16″, and by further comparison, the length of the smallest typical salad element, a sunflower seed, is 3/16″ and the width is approximately 1/16″. In consideration of all of the above, in a preferred embodiment of the present invention, the width of the tines 108 and the spacing 118 between tines 108 is nominally 1/16″. Also in a preferred embodiment, the thickness 142 of the tines 108 from top to bottom should be approximately 1/32″ and this would be similar to the dimensions at the “cutting end” of a butter knife.

It is to be appreciated that the present invention takes into account the varying dimensions of food items such as spaghetti, rice, salad, and a sunflower seed, which are usually eaten in a group of food, in adopting the dimensions for the width 134 of the tines 108, the spacing 118 between tine ends 114, and the thickness of the tines 142. Through this consideration, this invention provides a fork that is useful to capture through a twisting motion of the tines through a group of food items such as spaghetti, rice, salad, and a sunflower seed.

Referring now to FIG. 7, a partial cross-sectional view of the eating fork with reverse tapered tines as used using a typical meal, such as spaghetti. As shown, tines 108 have been positioned into spaghetti 200, and rotated in direction 202. Ends 114 have inserted into spaghetti so that the strands of spaghetti 200 have passed through gap 118. Once inserted, fork 100 is rotated in direction 202 so that spaghetti 200 twists against first portion 110 of tine 108; the reverse taper of second portion 112 of tine 108 prevents the spaghetti from moving in direction 204 and falling from the fork 100.

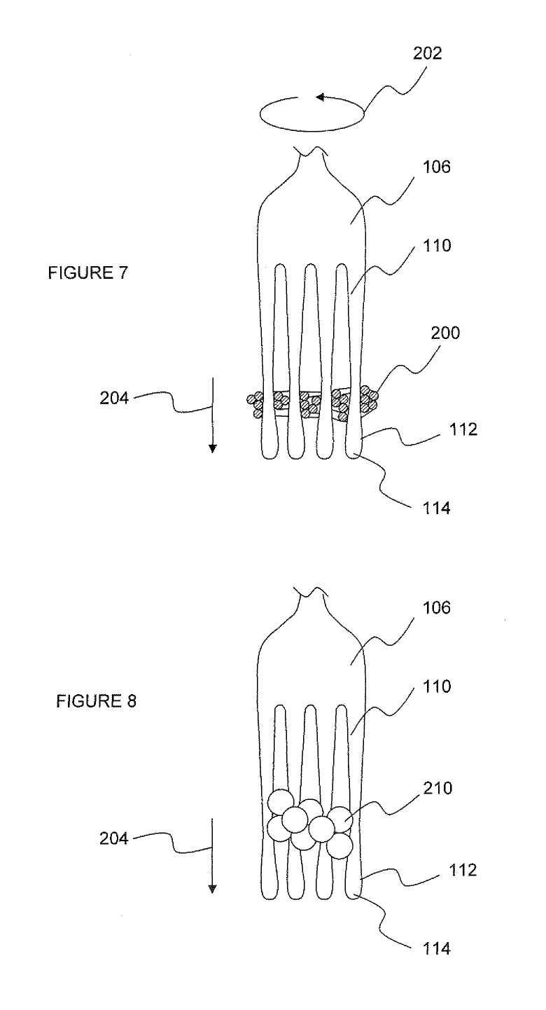

In another use, as shown in FIG. 8, a small food item, such as a pea 210 has been positioned on tines 108. Specifically, pea 210 has been positioned in cradle 150, and settles into the gap 120 shown in FIG. 2 between tines 108. The gap 120 receives the pea 210, and the reverse tapered shape of second portion 112 prevents the food item from rolling or sliding off fork 100 in direction 204.

In addition to the embodiment discussed above, it is to be appreciated that the tines may be parallel, as shown, or may be at angles to each other to create gaps 120 having different widths along the lengths of the tines 108. Also, while the specific dimensions set forth herein are directed to a preferred embodiment, it is to be appreciated that these dimensions are not limiting in scope of the present invention, and are mere examples of a preferred embodiment with alternative dimensions fully contemplated.

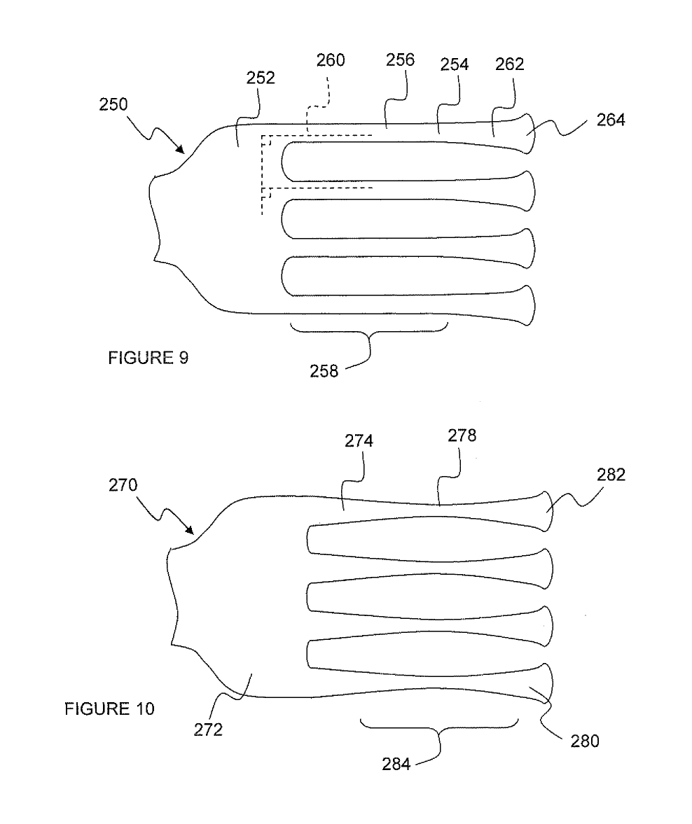

Referring now to FIG. 9, an alternative embodiment of the eating fork with reverse tapered tines of the present invention is shown and generally designated 250. Fork 250 includes a base 252 from which a number of identical tines 254 extend. Tines 254 include a parallel section 256 which extends nearly the entire length 258 of tine 254. As shown by dashed lines 260, tines 254 in this embodiment are parallel, and have a constant cross-section through length 258. Flared section 262 extends from parallel section 256 to form a reverse-tapered end 262. End 264 is shown, in this embodiment, to be rounded away from body 252, however, other curvatures or end shapes may be used without departing from the spirit of the present invention.

Referring to FIG. 10, an alternative embodiment of the eating fork with reverse tapered tines of the present invention is shown and generally designated 270. Fork 270 includes a base 272 from which a number of parallel tines 274 extend. Tines 274 of fork 270 are the same, and shaped to have a parabolicly narrowing width 278 along its midsection 284, and forming a reverse tapered portion 280 leading to end 282.

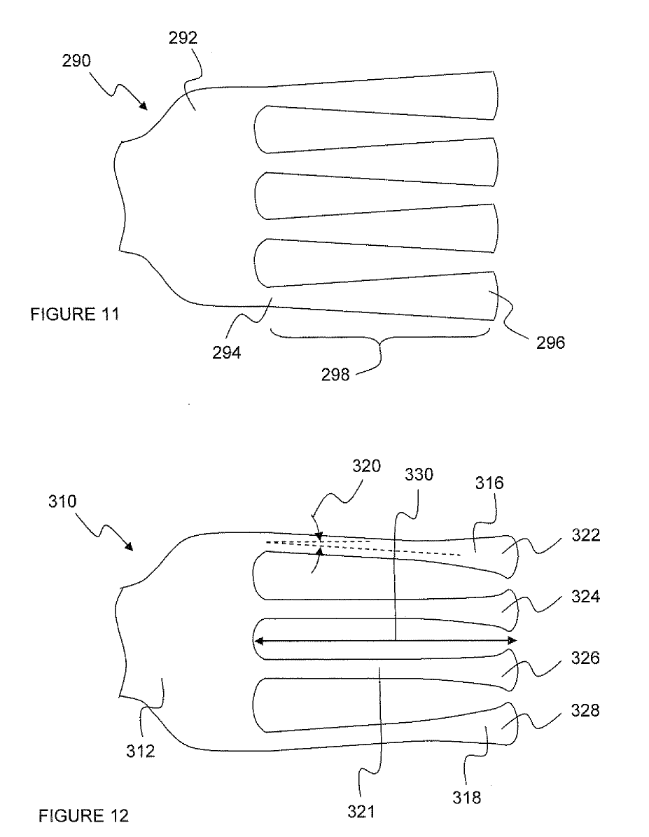

FIG. 11 shows yet another alternative embodiment of the eating fork with reverse tapered tines of the present invention generally designated 290. Fork 290 includes a base 292 from which a number of tines 294 extend having a constant taper section 298 which extends from the base 292 to the end 296 of the tine.

FIG. 12 is another alternative embodiment of the eating fork with reverse tapered tines of the present invention generally designated 310. Fork 310 includes a base 312 having two outer tines 316 and 318 that are not parallel. Specifically, tines 316 and 18 are offset an angle 320 from parallel and thus point inwards to fork 310. Interior tines 321 are parallel to each other. As shown, ends 322, 324, 326 and 328 are substantially the same distance from base 312.

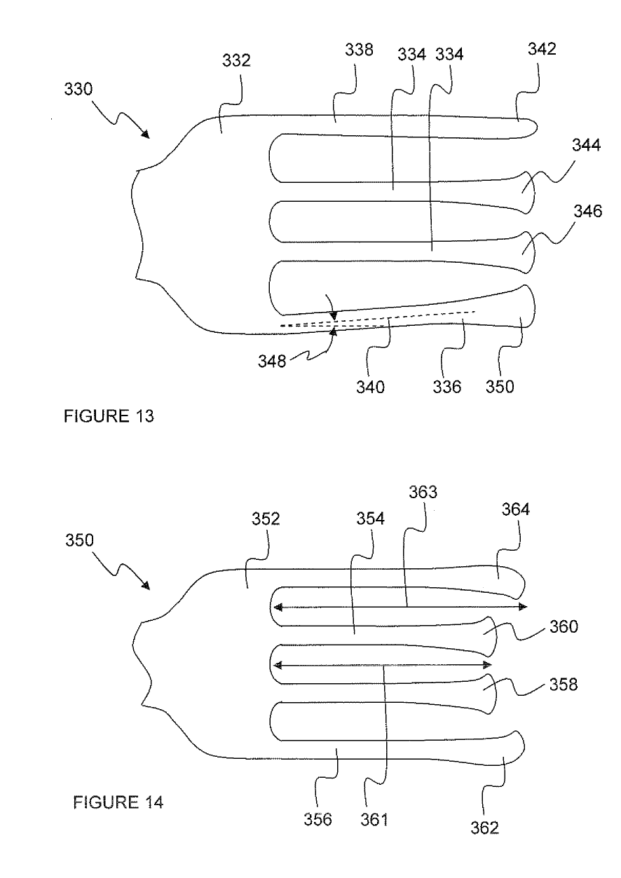

Referring now to FIG. 13, yet another alternative embodiment of the eating fork with reverse tapered tines of the present invention is shown and generally designated 330. Fork 330 includes different tine types. For instance, fork 330 includes a base 332 from which interior tines 334 and 335, and exterior tines 336 and 338 extend. Interior tines 334 and 335 are constant-cross-section tines that are formed with a reverse taper to ends 344 and 346. Exterior tine 338 is formed with a standard tine tip 342 having a non-reverse tapered shape. As shown, tines 334, 335 and 338 are parallel. Tine 336 is shown to be non-parallel to the other tines, as depicted by dashed lines 340 and angle 348. Tine 336 ends with reverse-tapered tine end 350.

From this figure, the placement of tine ends 342, 344, 346, and 350 are substantially the same distance from base 332. It is to be appreciated that the length of the tines can vary depending on the design of the fork, without departing form the scope of the present invention.

Referring to FIG. 14, an alternative embodiment of the eating fork with reverse tapered tines of the present invention is shown and generally designated 350. Fork 350 includes a base 352 from which two internal tines 354 and two external tines 356 extend. The internal tines 354 are formed to have a constant-cross-section and lead to a reverse-tapered end 358 and 360. Tines 358 and 360 are longitudinally symmetrical, and have a length 361.

External tines 356 are formed with a constant cross-section and lead to a reverse-tapered end 362 and 364. Also, external tines 356 are symmetrical and have a length 363. As can be appreciated from this Figure, the lengths 361 and 363 of the tines of the forks of the present invention may vary.

While there have been shown what are presently considered to be preferred embodiments of the present invention, it will be apparent to those skilled in the art that various changes and modifications can be made herein without departing from the scope and spirit of the invention.

1. An eating fork comprising:
a handle,
a body having a plurality of tines extending therefrom;
each said tine having a first portion adjacent to said body and having a substantially constant cross-section, and a second portion having a reverse taper extending away from said handle to an end.

2. The eating fork of claim 1, further comprising said end being formed with a rounded surface distal to said body.

3. The eating fork of claim 2, wherein each end is separated by a gap.

4. The eating fork of claim 2, wherein said gap is in the range of 3/64 to ⅛ inches.

5. The eating fork of claim 2, wherein said end has a width, and said width is in the range of 5/32 to 3/16 inches.

6. The eating fork of claim 1, wherein said substantially constant cross-section of said first portion of said tine is rectangular.

7. The eating fork of claim 1, wherein said reverse taper of said second portion is linear from said first portion to said end.

8. The eating fork of claim 1, wherein said reverse taper of said second portion is non-linear from said first portion to said end.

9. The eating fork of claim 1, wherein said tines are parallel.

10. The eating fork of claim 1, wherein said tines are not parallel.

11. The eating fork of claim 1, wherein said tips of the tines at said end are formed with a flattened cross-section.

12. The eating fork of claim 1, wherein said tines are formed to have a constant cross-section section, and a flared section that extends from constant cross-section section to form a reveres-tapered end.

13. The eating fork of claim 1, wherein said tines are shaped to have a parabolicly narrowing width along its midsection and forming a reverse tapered portion leading to an end.

14. The eating fork of claim 1, wherein said tines are formed to have a constant reverse taper section which extends from the base to the end of the tine.

15. The eating fork of claim 1, wherein said fork comprises two outer tines that are not parallel, and at least two Interior tines that are parallel to each other.

16. The eating fork of claim 15, further comprising said outer tines having a length, and said inner tines having a length, and wherein said length of the outer tines is different than the length of the inner tines.
